(19) United States
(12) Patent Application Publication
(10) Pub. No.: US 2009/0136309 A1
(43) Pub. Date: May 28, 2009

(54) APPARATUS AND METHOD FOR CHIP EVACUATION

(76) Inventors: George W. Coulston, Pittsburgh, PA (US); Thomas O. Muller, Greensburg, PA (US); Ted R. Massa, Latrobe, PA (US)

Correspondence Address: KENNAMETAL INC.;Intellectual Property Department, P.O. BOX 231, 1600 TECHNOLOGY WAY, LATROBE, PA, 15650, US

(21) Appl. No.: 11/946,317

(22) Filed: Nov. 28, 2007

(51) Int. Cl. B23B 47/34; B23B 35/00; B23B 51/00; B23B 47/00

(52) U.S. Cl. 408/200; 408/112; 408/1 R; 408/230; 408/76

(57) ABSTRACT

A chip evacuation device for evacuating chips from a workpiece is disclosed. The chip evacuation device includes a sleeve having a first end and a second end with a sidewall extending therebetween. The sidewall defines an interior between the first end and the second end and has a moveably biased portion. The first end is structured to contact the workpiece, and defines at least one vent hold extending through the sidewall adjacent the workpiece. The second end of the sleeve is structured to receive at least a portion of the cutting tool therethrough. The chip evacuation device also includes a vacuum apparatus in flow communication with the interior of the sleeve. A machine tool having a tool bit and a chip evacuation device surrounding the tool bit is also disclosed.

### BACKGROUND OF THE INVENTION

1. Field of the Invention

The subject invention relates to a chip evacuation device for removing chips from a workpiece during a metalworking operation. More particularly, this invention relates to a chip evacuation device for continuously removing by-product chips produced by a rotating tool from the surface of the workpiece.

2. Description of Related Art

During a metalworking operation, material removed from a workpiece usually has the configuration of a curled strip, known as a chip. Ideally, the material breaks into small c-shaped chips which are indicative of an efficient machining process. However, these chips are residual material that must be evacuated from the cutting region to provide an exit path for subsequently produced chips, and also to prevent these residual chips from interfering with the working process and potentially marring the surface of the workpiece.

It is also desirable to eliminate the re-cutting of by-product chips. Chips, which, if not removed from the cutting site, may be re-cut by the cutting tool. The re-cutting of chips increases wear on the cutting tool and can decrease the efficiency of the metalworking operation. This can be particularly true when cutting composite materials. In addition, the re-cutting of chips can increase the temperature of both the cutting tool and surrounding workpiece surface. Increased temperatures of the workpiece can result in deformations in the final product, such as the presence of burs, jagged edges, or deviations from preset tolerances. Increased temperatures of the cutting tool can result in increased stresses and shorter tool lifespan. This can be particularly true for deep drilling operations in which chips collect within the grooves of a drill bit and deep within the workpiece.

Accordingly, a need exists for a chip evacuation device that is capable of removing chips from the surface of a workpiece and that can be used with conventional cutting tools, such as drills and milling cutters, in particular end mills. A need also exists for a chip evacuation device that effectively evacuates chips while minimizing the re-cutting of chips.

### SUMMARY OF THE INVENTION

In one embodiment, the present invention is directed to a chip evacuation device for use with a tool bit for contacting a workpiece. The chip evacuation device includes a sleeve, and a vacuum apparatus in flow communication with the interior of the sleeve. The sleeve has a first end and a second end with a sidewall extending therebetween. The sidewall defines an interior between the first end and the second end and has a moveably biased portion. The first end is structured to contact a workpiece, and defines at least one vent hole extending through the sidewall adjacent the workpiece. The second end of the sleeve is structured to receive at least a portion of a cutting tool therethrough.

The cutting tool may be a drill bit or an end mill bit. The cutting tool path may be rotary or orbital. The first end of the sleeve can form a seal with the workpiece, and may optionally form a sliding seal with the workpiece. The first end can further include a seal enhancing layer for enhancing the between the chip evacuation device and the workpiece.

The sleeve may include a plurality of vent holes adjacent the first end. The vent holes can also be formed as a groove. The through-axis of the vent holes can be substantially perpendicular to the longitudinal axis of the sleeve, or the through axis of the vent holes can be angled with respect to the longitudinal axis of the sleeve.

In another embodiment, the present invention is directed to an arrangement including a cutting tool and a chip evacuation device surrounding the cutting tool. The chip evacuation device includes a sleeve, and a vacuum apparatus in flow communication with the interior of the sleeve. The sleeve has a first end and a second end with a sidewall extending therebetween. The sidewall defines an interior between the first end and the second end and has a moveably biased portion. The first end is structured to contact a workpiece, and defines at least one vent hole extending through the sidewall adjacent the workpiece. The second end of the sleeve is structured to receive at least a portion of a cutting tool therethrough.

The machine tool can be a drill or a milling cutter, such as an end mill. Optionally, the cutting tool can include a shank and a cutting end with a through-hole extending between a portion of the shank through a portion of the cutting end to an exterior surface of the cutting tool.

In another embodiment, the present invention is directed to a method including the steps of: providing a workpiece, and providing a machine tool having a cutting tool, and a chip evacuation device for surrounding the cutting tool. The method also includes the steps of contacting the workpiece with the cutting tool; rotating the cutting tool to produce chips from the workpiece; and evacuating the chips from the workpiece through the chip evacuation device. The chip evacuation device includes a sleeve, and a vacuum apparatus in flow communication with the interior of the sleeve. The sleeve has a first end and a second end with a sidewall extending therebetween. The sidewall defines an interior between the first end and the second end and has a moveably biased portion. The first end is structured to contact the workpiece, and defines at least one vent hole extending through the sidewall adjacent the workpiece. The second end of the sleeve is structured to receive at least a portion of a cutting tool therethrough.

### BRIEF DESCRIPTION OF THE DRAWINGS

FIG. 1 is a cross-sectional front view of a chip evacuation device having a cutting tool disposed therein and engaging a workpiece in accordance with an embodiment of the present invention.

FIG. 1A is a cross-sectional front view of a chip evacuation device forming a seal with an uneven surface of a workpiece in accordance with the present invention.

FIG. 2 is a perspective view of a chip evacuation device in accordance with an embodiment of the present invention.

FIG. 3 is a top view of the chip evacuation device of FIG. 1 having a tool bit disposed therein in accordance with an embodiment of the present invention.

FIG. 4 is a bottom view of the chip evacuation device of FIG. 1 having a tool bit disposed therein in accordance with an embodiment of the present invention.

FIG. 5 is a bottom view of a rotary cutting tool for use in the chip evacuation device of the present invention.

FIG. 6 is a bottom view of a cutting tool in an orbital path, for use in the chip evacuation device of the present invention.

FIG. 7 is a cross-sectional bottom view along lines A-A in FIG. 1 of the first end of the chip evacuation device taken perpendicular to the longitudinal axis of FIG. 1, the first end having vent holes that are substantially perpendicular to the longitudinal axis of the sleeve in accordance with an embodiment of the present invention.

FIG. 8 is an alternative cross-sectional bottom view along lines A-A in FIG. 1 of the first end of the chip evacuation device taken perpendicular to the longitudinal axis of FIG. 1, the first end having vent holes that are axially angled with respect to the longitudinal axis of the sleeve in accordance with an embodiment of the present invention.

FIG. 8A is a cross-sectional bottom view along lines A-A in FIG. 1 of an alternative embodiment of the first end of a chip evacuation taken perpendicular to the longitudinal axis L of FIG. 1.

FIG. 9 is a cross-sectional side view of the first end of the chip evacuation device having vent holes that are substantially perpendicular to the longitudinal axis of the sleeve in accordance with an embodiment of the present invention.

FIG. 9A is a cross-sectional side view of the first end of the chip evacuation device having vent holes that are substantially perpendicular to the longitudinal axis of the sleeve and adjacent an end of the sleeve in accordance with an embodiment of the present invention.

FIG. 10 is a cross-sectional side view of an alternative embodiment of the first end of a chip evacuation device taken along the longitudinal axis L of section B of FIG. 1 having vent holes that are angled with respect to the longitudinal axis of the sleeve in accordance with an embodiment of the present invention.

FIG. 10A is a cross-sectional side view of an alternative embodiment of the first end of a chip evacuation device taken along the longitudinal axis L of section B of FIG. 1 having vent holes that are angled with respect to the longitudinal axis of the sleeve in accordance with an embodiment of the present invention.

FIG. 11 is a cross-sectional front view of an alternative chip evacuation device having a cutting tool disposed therein and engaging a workpiece in accordance with an embodiment of the present invention.

FIG. 12 is a perspective view of a chip evacuation device in accordance with an alternative embodiment of the present invention.

### DESCRIPTION OF THE PREFERRED EMBODIMENTS

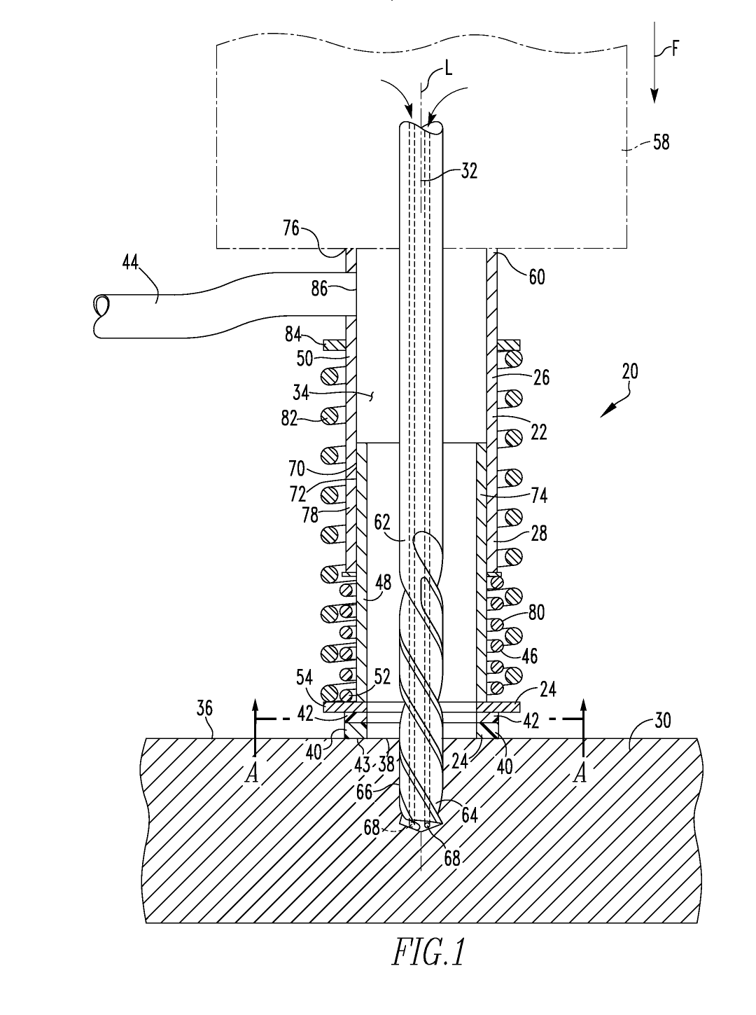

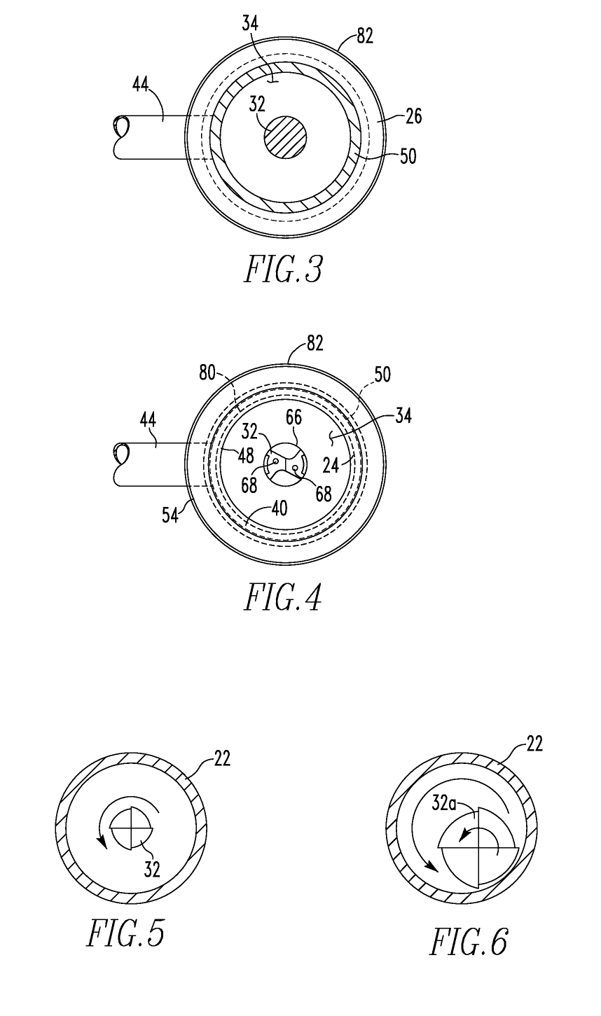

As shown in FIGS. 1-4, the chip evacuation device 20 of the present invention removes chips produced from a cutting process from the cutting site. The chip evacuation device 20 includes a sleeve 22 having a first end 24 and a second end 26 opposite the first end 24 with a sidewall 28 extending therebetween. In one embodiment, the first end 24 and the second end 26 are open and the interior 34 of the sleeve 22 is generally hollow. The first end 24 is structured to generally contact a workpiece 30, and the second end 26 is structured generally to receive at least a portion of a cutting tool 32 therethrough. While a cutting tool associated with a drill will be discussed to illustrate the invention, it should be appreciated that any number of different cutting tools may be used with the subject invention.

The sleeve 22 may be made of a flexible or semi-flexible material allowing for the sleeve 22 to bend thereby changing the orientation of the second end 26 relative to the first end 24 without damage to the sleeve 22. In general, the sleeve 22 is made of metal, however, the sleeve 22 may be made of a polymeric material, or a natural and/or synthetic woven fabric.

The workpiece 30 may be any article into which it is desired to produce a hole, recess, groove, or the like. The workpiece 30 may be a finished product, a quasi-finished product, an unfinished component or a raw material. The workpiece 30 can be any type of machinable material, such as metal, wood, polymeric material, ceramic, and/or composites thereof.

In one embodiment, the first end 24 of the sleeve 22 may be configured to form a removable seal, such as a gas-tight and/or liquid-tight seal, with a surface 36 of a workpiece 30. At least a portion of the first end 24 may be made of a material, such as natural or synthetic rubber which conforms to the surface of the workpiece. Alternatively, the sleeve 22 may include a seal enhancing layer 40 adjacent the first end 24 for conforming to the surface 36 of the workpiece 30. In one embodiment, the seal enhancing layer 40 can be made of resilient material and is optimally coated with a coating for enhancing the slideability of the sleeve 22 on the workpiece 30. In one embodiment, the coating may be polytetrafluoroethylene (PTFE). The seal enhancing layer 40 can be substantially continuous about the first end 24. Alternatively, the seal enhancing layer 40 can be provided in segmented regions about a portion of the first end 24. The seal enhancing layer 40 can be provided in any suitable thickness.

It is also contemplated herein that the first end 24 of the sleeve 22 can form a sliding seal with a surface 36 of the workpiece 30 such that the sleeve 22 can be moved along the surface 36 without breaching the seal formed therewith.

It is further contemplated herein, that the surface 36 of the workpiece 30 may not be entirely contained within a single plane. As shown in FIG. 1A, the uneven surface 36 of the workpiece 30 may be contained within multiple planes (A, B). Accordingly, the first end 24 of the sleeve 22 may include a flexible portion 47 for allowing the first end 24 to flex about the longitudinal axis L of the sleeve 22 such as in a left or right diagonal alignment, as shown by arrows C and D. The flexible portion 47 can include a flexible material allowing for articulation of the sleeve 22 to accommodate varying surface heights. Under certain circumstances, the thickness of the seal enhancing layer 40 may be increased to accommodate the uneven surface.

The second end 26 of the sleeve 22 is structured to receive at least a portion of the tool housing 58 (FIG. 1), which supports the cutting tool 32. In another embodiment, the second end 26 of the sleeve 22 may include an additional sealing layer 60 for providing a removable seal with the tool housing 58.

The tool housing 58 can be a housing for any number of cutting tools, such as a drill or a milling cutter. Drills suitable for use with the chip evacuation device of the present invention include, for example, hammer drills, rotary hammer drills, jackhammers, pneumatic drills, drill presses, geared head drills, and radial arm drills. Example milling cutters suitable for use with the chip evacuation device of the present invention include, for example, vertical mill milling cutters, horizontal mill milling cutters, universal mill milling cutters, box or column mill milling cutters, turret or vertical ram milling cutters, C-frame milling cutters, knee mill milling cutters, bed mill milling cutters, jig borer milling cutters, horizontal boring mill milling cutters, floor mill milling cutters, portical mill milling cutters, and ball nose end mill milling cutters. As shown in FIG. 5, the cutting tool 32 positioned within the sleeve 22 can be a rotary bit structured for rotary cutting along a single axis. As shown in FIG. 6, the cutting tool 32a positioned within the sleeve 22 can be a rotary bit structured for orbital cutting. With particular reference to FIGS. 1 and 4, the cutting tool 32 includes a shank 62 and a cutting end 64 with at least one through-hole 68 extending between an interior portion of the shank 62 and to an exterior surface 66 of the cutting tool 32. Gas and/or liquid may be passed from a portion of the tool (shown in FIG. 1) through the shank 62 of the cutting tool 32 and exit the cutting tool 32 via through-hole 68 to deliver gas and/or liquid to the cutting site.

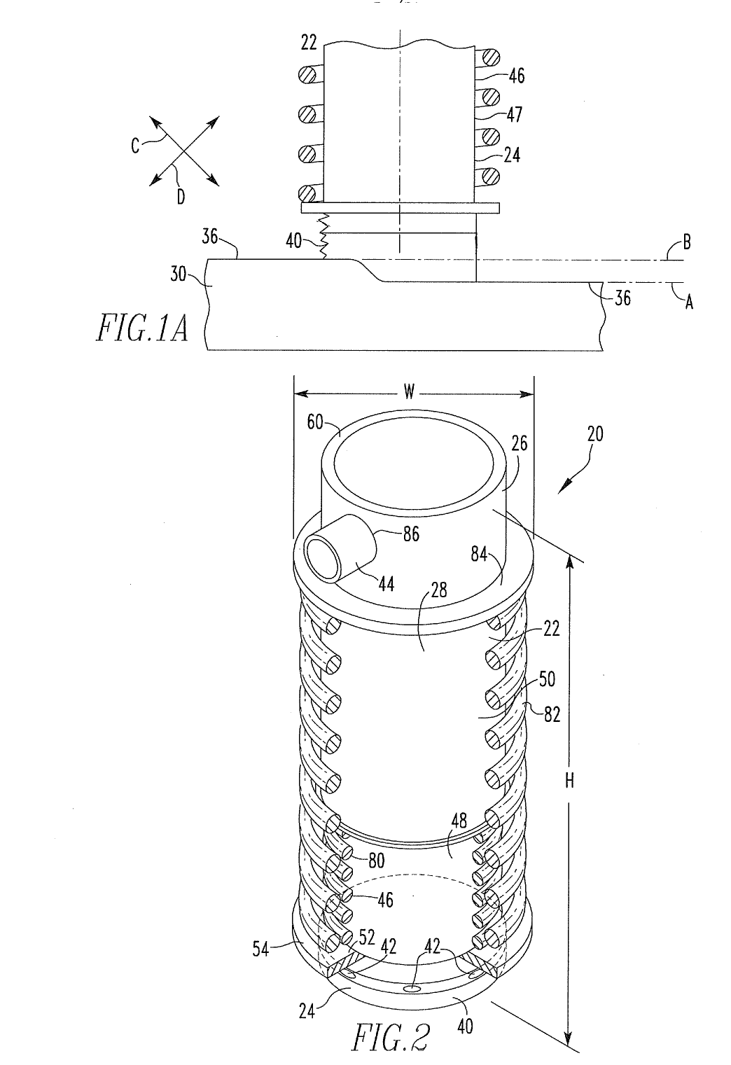

Referring again to FIG. 1, the sleeve 22 can have any suitable dimensions such that the cutting tool 32 can be received within the second end 26 and extend through the interior 34 of the sleeve 22 to contact a surface 36 of the workpiece 30 at a desired cutting site 38. As shown in FIG. 2, the sleeve 22 can have a height H of from about 0.5 inch to about 24 inches and a width W of from about 0.25 inch to about 8 inches. The sleeve 22 may be substantially cylindrical with a substantially circular cross-section, however, it is important for the sleeve 22 to provide access for the cutting tool 32 and a passageway for fluid flow within to evacuate chips. As a result, while the sleeve 22 is illustrated as a cylinder, it may have any number of different shapes.

The sidewall 28 of the sleeve 22 also includes a moveably biased portion 46 which allows the height H of the sleeve 22 to compress to accommodate changes in the position of the tool housing 58 as a result of a cutting process. For example, as a hole is bored into the workpiece 30 (FIG. 1) at the cutting site 38, the cutting tool 32 is lowered along the longitudinal axis L to a recessed depth within the workpiece 30. In order to maintain a sealed environment between the workpiece 30 and the tool housing 58, the sleeve 22 is capable of compressing and accommodating changes in height along the longitudinal axis. In one embodiment, the moveably biased portion 46 includes telescoping segments (FIG. 1) wherein a first telescoping segment 48 is at least partially nested within a second telescoping segment 50. In this configuration, a portion of the outer surface 70 of the first telescoping segment 48 slideably contacts a portion of the inner surface 72 of the second telescoping segment 50. A portion of the second telescoping segment 50 circumferentially surrounds a portion of the first telescoping segment 48.

As shown in FIG. 1, the first telescoping segment 48 may have a contact end 52 for engaging a first restraining plate 54 disposed about the longitudinal axis of the sleeve 22 adjacent the first end 24. The first telescoping segment 48 may also have a first end 74 for slideably engaging the second telescoping segment 50. The second telescoping segment 50 likewise may have a contact end 76 for engaging a portion of the tool housing 58 adjacent the second end 26, such as adjacent the additional sealing layer 60. The second telescoping segment 50 may also have a sliding end 78 for slideably engaging the first end 74 of the first telescoping segment 48. In one configuration, a spring 80 can be disposed between the first restraining plate 54 and the sliding end 78 of the second telescoping portion 50 to allow the second telescoping portion 50 to be slid along the longitudinal axis L over the first telescoping portion 48 when pressure is applied in the direction indicated by arrow F from the tool housing 58 toward the workpiece 30.

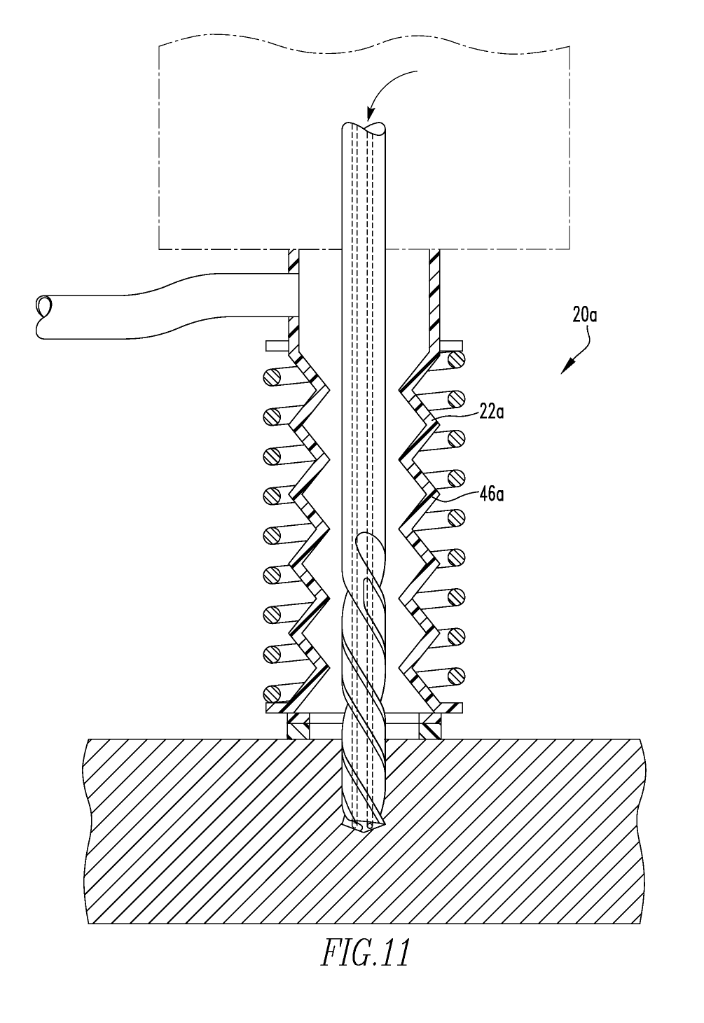

In another embodiment, also shown in FIG. 1, a spring 82 can be biased between the first restraining plate 54 and a second restraining plate 84 disposed about the longitudinal axis of the sleeve 22 adjacent the second end 26. The spring 82 can be used in conjunction with the first and second telescoping segments 48, 50 and the spring 80 biased therebetween. Although shown including two springs 80, 82 it is contemplated herein that a single spring may be employed in the present invention. Alternatively, the spring 82 can be employed in the chip evacuation device 20 without the first and second telescoping segments 48, 50. In this configuration, the entire sleeve 22 can be compressed, such as in an accordion fashion (FIG. 11), rather than just a portion of it, as in the case of the compression of the second telescoping segment 50 over the first telescoping segment 48. It is contemplated herein that the spring 82 can be disposed on the exterior of the sleeve 22 as shown in FIG. 1, within the interior 34 of the sleeve 22, and/or within the sidewall 28 of the sleeve 22.

Referring again to FIGS. 1-2, the first end 24 of the sleeve 22 defines at least one vent hole 42 extending through the sidewall 28 adjacent the workpiece 30. The vent hole 42 is structured to allow ambient air or other gas to be drawn from the exterior of the sleeve 22 into the interior 34 of the sleeve 22 adjacent the cutting site 38. In one embodiment, a plurality of vent holes 42 are defined within the sidewall 28 adjacent the workpiece 30 to increase the flow of ambient air to the cutting site 38. The vent holes 42 can have any number of different sizes and shapes to control the amount of air directed to the cutting site 38. The purpose of the vent holes 42 is not only to provide an inlet for outside air to enter the interior 34 of the sleeve 22, but also to direct the incoming air to produce a flow pattern within the interior 34 that will promote evacuation of the chips and dust from the cutting site 38. In one embodiment, the vent holes 42 are substantially circular. In another embodiment, the vent holes 42 may be provided as grooves such that the vent hole 42 could be easily cleared by lifting the cutting tool 32 off of the workpiece 30 to unclog the groove. In addition, the vent holes 42 formed as grooves can optimize air flow and minimize stagnant areas.

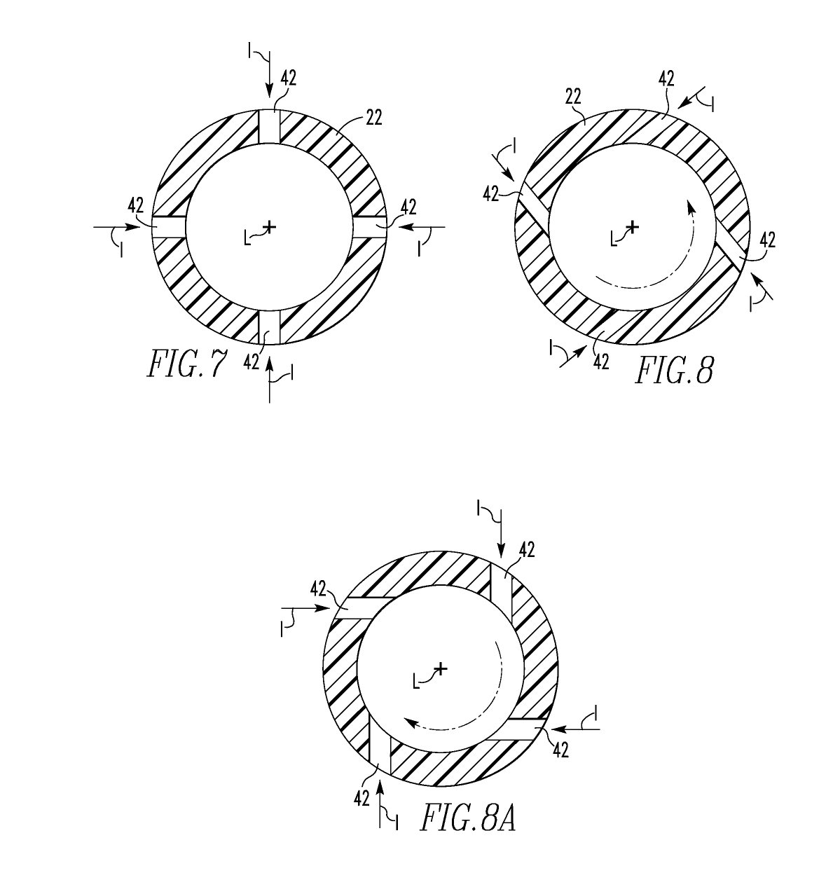

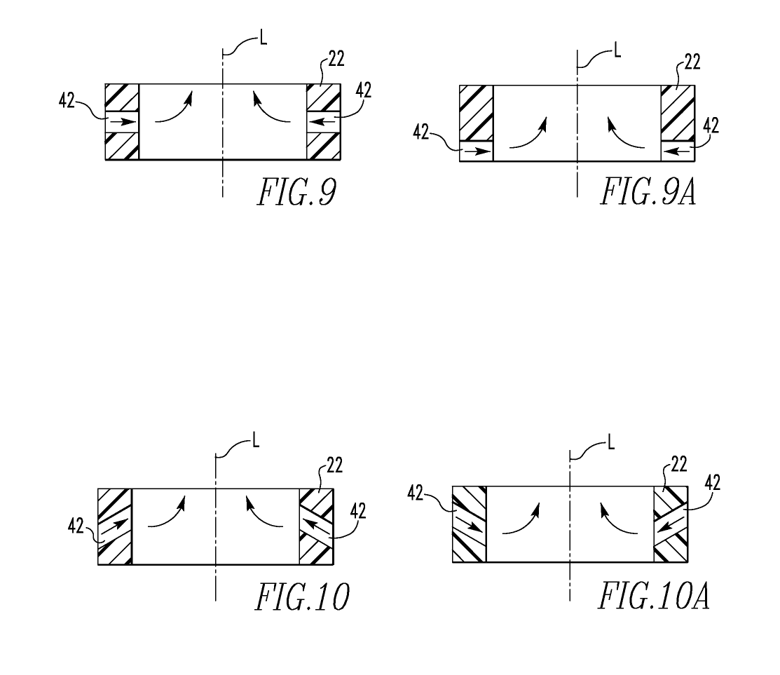

As shown in FIG. 7, the vent holes 42 can define a through-axis in which air may flow that is oriented within the sleeve 22 in a direction that is substantially radial to the longitudinal axis L of the sleeve 22 along a lateral plane. The longitudinal axis L is shown in FIG. 7 as extending into the page. Alternatively, as shown in FIG. 8, the vent holes 42 can define a through-axis which may be oriented within the sleeve 22 in a direction that is angled within a lateral plane with respect to the longitudinal axis L of the sleeve 22 between an orientation extending radically from the longitudinal axis and extending perpendicular to a radial line extending from the longitudinal axis. In one embodiment, the vent holes 42 can be angled in the lateral direction with respect to the longitudinal axis L. As shown in another alternative embodiment in FIG. 8A, the vent holes 42 can be offset to induce air drawn into the interior 34 of the sleeve 22 to follow a swirling pattern. In one embodiment, air can be forced into the vent holes 42 shown in FIGS. 7-8A in the direction indicated by arrows I.

As shown in FIGS. 9 and 9A, the vent holes 42 can define a through-axis in which air may flow that is oriented within the sleeve 22 in a direction that is substantially perpendicular to the longitudinal axis L of the sleeve 22 along a longitudinal plane. The longitudinal axis L is shown in FIGS. 9 and 9A as extending with the page. In another embodiment, as shown in FIG. 9A, the vent holes 42 can be positioned adjacent a bottom end 43 of the sleeve 22.

As shown in FIGS. 10 and 10A, the vent holes 42 can define a through-axis which may be oriented within the sleeve 22 in a direction that is longitudinally skewed with respect to the longitudinal axis L of the sleeve 22. The longitudinal axis L is shown also in FIGS. 10 and 10A as extending along the page. In one embodiment, the vent holes 42 can be angled in the longitudinally skewed direction with respect to the longitudinal axis L.

Referring yet again to FIGS. 1 and 2, the chip evacuation device 20 further includes a vacuum port 86 connected to a vacuum apparatus 44 extending through the sidewall 28 adjacent the second end 26 of the sleeve 22. The vacuum apparatus 44 is structured to draw gas entering the sleeve 22 through the vent hole(s) 42 and/or pressurized air forced through the cutting tool 32 to the cutting site 38 adjacent the first end 24 and out the port 86. The vacuum apparatus 44 can have any suitable arrangement having sufficient suction to draw chips created by the cutting action of the cutting tool 32 into the workpiece 30 at the cutting site 38 out of the sleeve 22 and through the port 86. In another embodiment, the vacuum apparatus 44 is connected to a collection facility (not shown) for receiving chips therein.

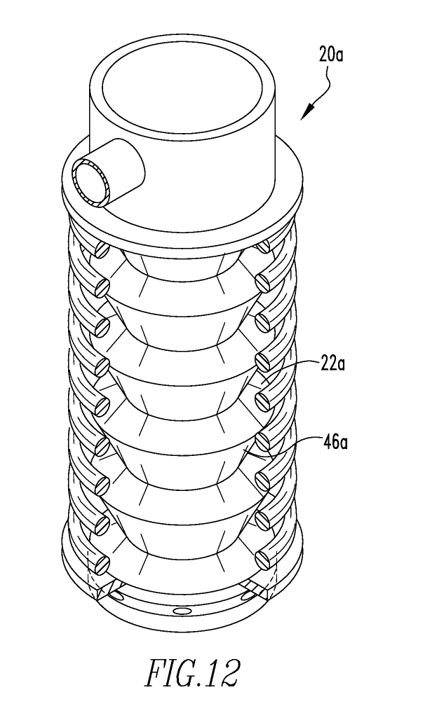

In an alternative embodiment, shown in FIGS. 11-12, the chip evacuation device 20a includes a sleeve 22a having a moveably biased portion 46a having an accordion configuration in which portions of the sleeve can fold to compress the sleeve 22a to a desired height.

While the present invention is described with reference to several distinct embodiments of a mechanical separator assembly and method of use, those skilled in the art may make modifications and alterations without departing from the scope and spirit. Accordingly, the above detailed description is intended to be illustrative rather than restrictive.

What is claimed is:

1. A chip evacuation device for use with a machine tool for contacting a workpiece, comprising:
a sleeve, having a first end and a second end with a sidewall extending therebetween, the sidewall defining an interior between the first end and the second end and having a moveably biased portion, the first end structured to contact a workpiece and defining at least one vent hole extending through the sidewall adjacent the workpiece, and a second end for receiving at least a portion of the cutting tool therethrough; and
a vacuum port in flow communication with the interior of the sleeve.

2. The chip evacuation device of claim 1, wherein the cutting tool is a drill bit or a milling cutter bit.

3. The chip evacuation device of claim 1, wherein the tool bit is a rotary bit traveling in an axial or orbital path.

4. The chip evacuation device of claim 1, wherein the workpiece is metal, wood, polymeric material, ceramic, and/or composites thereof.

5. The chip evacuation device of claim 1, wherein the moveably biased portion includes telescoping segments.

6. The chip evacuation device of claim 1, wherein the moveably biased portion comprises a spring.

7. The chip evacuation device of claim 1, wherein the moveably biased portion comprises an accordion folding segment.

8. The chip evacuation device of claim 1, wherein the first end forms a substantially gas-tight and/or liquid-tight seal with the workpiece.

9. The chip evacuation device of claim 1, wherein the first end forms a sliding seal with the workpiece.

10. The chip evacuation device of claim 1, further comprising a seal enhancing layer adjacent the first end.

11. The chip evacuation device of claim 1, wherein the sleeve defines a plurality of vent holes adjacent the first end.

12. The chip evacuation device of claim 1, wherein the at least one vent hole is formed as a groove.

13. The chip evacuation device of claim 1, wherein a through-axis of the at least one vent hole is substantially perpendicular to a longitudinal axis of the sleeve.

14. The chip evacuation device of claim 1, wherein a through-axis of the at least one vent hole is angled with respect to a longitudinal axis of the sleeve.

15. A machine tool, comprising:
a cutting tool; and
a chip evacuation device for surrounding the cutting tool, the chip evacuation device comprising:
a sleeve, having a first end and a second end with a sidewall extending therebetween, the sidewall defining an interior between the first end and the second end and having a moveably biased portion, the first end structured to contact a workpiece and defining at least one vent hole extending through the sidewall adjacent the workpiece, and a second end for receiving at least a portion of the tool therethrough, and
a vacuum apparatus in flow communication with the interior of the sleeve.

16. The machine tool of claim 15, wherein the tool is a drill.

17. The machine tool of claim 16, wherein the drill is a hammer drill, a rotary hammer drill, a jackhammer, a pneumatic drill, a drill press, a geared head drill, or a radial arm drill.

18. The machine tool of claim 15, wherein the tool is a milling cutter.

19. The machine tool of claim 18, wherein the milling cutter is a vertical mill milling cutter, a horizontal mill milling cutter, a universal mill milling cutter, a box or column mill milling cutter, a turret or vertical ram milling cutter, a C-frame milling cutter, a knee mill milling cutter, a bed mill milling cutter, a jig borer milling cutter, a horizontal boring mill milling cutter, a floor mill milling cutter, a portical mill milling cutter, or a ball nose end mill milling cutter.

20. The machine tool of claim 15, wherein the cutting tool comprises a shank and a cutting end and defines the at least one through-hole extending between an interior portion of the shank through a portion of the cutting end to an exterior surface of the cutting tool.

21. The machine tool of claim 15, wherein the sleeve defines a plurality of vent holes adjacent the first end.

22. The machine tool of claim 15, wherein a through-axis of the at least one vent hole is substantially perpendicular to a longitudinal axis of the sleeve.

23. The machine tool of claim 15, wherein a through-axis of the at least one vent hole is angled with respect to a longitudinal axis of the sleeve.

24. A method, comprising the steps of:
providing a workpiece;
providing a machine tool comprising a cutting tool, and a chip evacuation device for surrounding the cutting tool, the chip evacuation device comprising:
a sleeve, having a first end and a second end with a sidewall extending therebetween, the sidewall defining an interior between the first end and the second end and having a moveably biased portion, the first end structured to contact the workpiece and defining at least one vent hole extending through the sidewall adjacent the workpiece, and a second end for receiving at least a portion of the tool therethrough, and
a vacuum apparatus in flow communication with the interior of the sleeve;
contacting the workpiece with the cutting tool;
rotating the tool bit to produce chips from the workpiece; and
evacuating the chips from the workpiece through the chip evacuation device.
